(19) United States
(12) Patent Application Publication
(10) Pub. No.: US 2025/0056357 A1
(43) Pub. Date: Feb. 13, 2025

(54) METHOD AND APPARATUS FOR SUPPORTING USER EQUIPMENT MOBILITY IN WIRELESS COMMUNICATION SYSTEM

(71) Applicant: Samsung Electronics Co., Ltd., Gyeonggi-do (KR)

(72) Inventor: Youngkyo BAEK, Gyeonggi-do (KR)

(21) Appl. No.: 18/797,002

(22) Filed: Aug. 7, 2024

(30) Foreign Application Priority Data
Aug. 10, 2023 (KR) 10-2023-0105137

(51) Int. Cl. H04W 36/26; H04W 36/00; H04W 36/08

(52) U.S. Cl. CPC H04W 36/26; H04W 36/0011; H04W 36/08

(57) ABSTRACT

The disclosure relates to a 5G or 6G communication system for supporting a higher data transmission rate. A method of a session management function (SMF) entity in a wireless communication system includes: receiving, from a target base station, a first message for a handover; identifying whether the first message includes a first indication indicating a protocol data unit (PDU) set-based handling support of the target base station; and transmitting, to the target base station, at least one PDU set quality of service (QOS) parameter based on the first indication.

### CROSS-REFERENCE TO RELATED APPLICATION(S)

This application is based on and claims priority under 35 U.S.C. § 119 to Korean Patent Application No. 10-2023-0105137, filed on Aug. 10, 2023, in the Korean Intellectual Property Office, the disclosure of which is incorporated herein by reference in its entirety.

### BACKGROUND

### 1. Field

The disclosure relates generally to a wireless communication system, and more particularly, to a method and an apparatus for supporting user equipment (UE) mobility in view of an extended reality (XR) service supporting quality of service (QOS) in an application level in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial stage of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with XR for efficiently supporting augmented reality (AR), virtual reality (VR), and the like (XR=AR+VR+MR), 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided. As such, there is a need for improved manners by which to effectively provide these services.

For example, a 5G system supports a network slice, and traffic relating to different network slices may be processed by different protocol data unit (PDU) sessions, which refer to associations between a UE and a data network that provides a PDU connection service. A network slice is a set of network functions (NFs) for supporting various services with different characteristics, such as a broadband communication service, massive IoT, and a mission-critical service including V2X, and is a technology for logically configuring a network and separating different network slices. Thus, even though a communication failure occurs in a network slice, communication in another network slice is not affected, thus enabling the provision of a stable communication service. The term slice may be used interchangeably with network slice. In this network environment, a UE may access a plurality of network slices when provided with various services. The NF is a software instance running on hardware, and may be configured as a network element or as a virtualized function instantiated on an appropriate platform.

A mobile network operator may configure a network slice, and may allocate a network resource suitable for a specific service for each network slice or each set of network slices. A network resource may refer to an NF, a logical resource provided by the NF, or a radio resource allocated by a base station.

For example, a mobile network operator may configure network slice A to provide a mobile broadband service, network slice B to provide a vehicular communication service, and network slice C to provide an XR service. That is, in a 5G network, each service may be efficiently provided to a UE through a network slice specialized for a characteristic of the service, and a network slice may be represented by single-network slice selection assistance information which includes a slice/service type (SST) value and a slice differentiator (SD) value. An SST may represent a characteristic of an eMBB, IoT, URLLC, V2X, or XR service supported by a network slice. An SD value is used as an additional identifier for a specific service referred to by an SST.

Examples of services that require a high data rate and low latency (high-data-rate low-latency (HDRLL) services) may include an XR service, an augmented reality (AR) service, a virtual reality (VR) service, or a cloud gaming service. The VR service provides a virtual environment realized by a computer device by using a VR headset and the like. The AR service combines the real world and a virtual environment by using a location, geographic information, and the like. The XR service not only combines a real environment and a virtual environment but also provides a user with haptic, auditory, and olfactory information to enhance the user's experience.

When various types of XR service data, such as audio, video, and haptic data, are delivered to a user, a packet corresponding to an application data unit (ADU) of an application needs to be delivered to a UE according to characteristics of the application to deliver significant information. Therefore, when packets belonging to one ADU are not properly transmitted or a certain packet fails to be transmitted, even though transmitted packets belonging to the ADU are delivered to the UE, ADU information may not be delivered to the user.

Accordingly, there is a need in the art for a method and apparatus to cure such transmission shortcomings in the conventional art.

### SUMMARY

The disclosure has been made to address at least the above-mentioned problems and/or disadvantages and to provide at least the advantages described below.

Accordingly, an aspect of the disclosure is to provide a method and an apparatus for using QoS with application-level characteristics reflected when a service requiring ultrahigh-speed and low-latency communication, such as an XR service, is offered in a wireless communication system.

An aspect of the disclosure is to provide a method by which, when a service supporting application-level QoS is offered, the mobility of a UE may be supported to smoothly transmit data traffic in a handover, thereby improving service quality.

In accordance with an aspect of the disclosure, a method of a session management function (SMF) entity in a wireless communication system includes receiving, from a target base station, a first message for a handover; identifying whether the first message includes a first indication indicating a protocol data unit (PDU) set-based handling support of the target base station; and transmitting, to the target base station, at least one PDU set quality of service (QOS) parameter based on the first indication.

In accordance with an aspect of the disclosure, an SMF entity in a wireless communication system includes a transceiver, and at least one processor coupled to the transceiver and configured to receive, from a target base station, a first message for a handover; identify whether the first message includes a first indication indicating a protocol data unit (PDU) set-based handling support of the target base station; and transmit, to the target base station, at least one PDU set quality of service (QOS) parameter based on the first indication.

In accordance with an aspect of the disclosure, a method of a target base station in a wireless communication system includes transmitting, to a session management function (SMF) entity, a first message for a handover; and receiving, from the SMF entity, at least one PDU set quality of service (QOS) parameter in case that the first message includes a first indication indicating a protocol data unit (PDU) set-based handling support of the target base station.

In accordance with an aspect of the disclosure, a target base station in a wireless communication system, the target base station comprising: a transceiver; and at least one processor coupled to the transceiver and configured to: transmit, to a session management function (SMF) entity, a first message for a handover, and receive, from the SMF entity, at least one PDU set quality of service (QOS) parameter in case that the first message includes a first indication indicating a protocol data unit (PDU) set-based handling support of the target base station.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates an example of a transmission path for data traffic in a handover in a wireless communication system according to an embodiment;

FIG. 2 illustrates a handover method considering a PDU set function in an Xn handover (i.e., inter-radio access node (RAN) handover) in a wireless communication system according to an embodiment;

FIG. 3 illustrates a handover method considering a PDU set function in an N2 handover in a wireless communication system according to an embodiment;

FIG. 4 illustrates a handover method considering whether a core network uses a PDU set recognition function in an Xn handover of a high-speed UE in a wireless communication system according to an embodiment;

FIG. 5 illustrates a handover method considering whether a core network uses a PDU set recognition function in an N2 handover of a UE in a wireless communication system according to an embodiment;

FIG. 6 illustrates a method of determining whether to use a PDU set function through a report of a core network in a handover in a wireless communication system according to an embodiment;

FIG. 7 illustrates a method of determining whether to use a PDU set function when a UPF is changed in a wireless communication system according to an embodiment;

FIG. 8 illustrates an operation of an SMF according to an embodiment; and

FIG. 9 illustrates the structure of a network node according to an embodiment.

### DETAILED DESCRIPTION

Hereinafter, embodiments of the disclosure will be described in detail with reference to the accompanying drawings. A detailed descriptions of known functions or configurations incorporated herein will be omitted for the sake of clarity and conciseness.

The terms which will be described below are terms defined in consideration of the functions Herein, and may be different according to users, intentions of the users, or customs. Therefore, the definitions of the terms should be made based on the contents throughout the specification.

For the same reason, in the accompanying drawings, some elements may be exaggerated, omitted, or schematically illustrated. The size of each element does not completely reflect the actual size. In the respective drawings, identical or corresponding elements are provided with identical reference numerals.

The disclosure is not limited to the embodiments set forth below, but may be implemented in various different forms. The following embodiments are provided only to completely disclose the disclosure and inform those skilled in the art of the scope of the disclosure, and the same or like reference numerals designate the same or like elements.

Herein, an element is expressed in the singular or the plural according to presented embodiment. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The configuration and structural diagrams disclosed herein are not intended to limit the scope of the disclosure. That is, all constituent elements, entities, or operation steps described herein should not be construed as being essential for the implementation of the disclosure, and the disclosure may be implemented without impairing the essential features of the disclosure by including only some constituent elements. In addition, the respective embodiments may be employed in combination, as necessary. For example, the methods disclosed herein may be partially combined with each other to operate a network entity and a terminal.

As used herein, each of such phrases as “A/B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in importance or order.

Herein, a base station (BS) is an entity that allocates resources to terminals, and may be at least one of a gNode B, an eNode B, a Node B, a wireless access unit, a base station controller, and a node on a network. A UE may be referred to as a terminal, a mobile station (MS), a cellular phone, a smartphone, a computer, or various types of electronic devices capable of performing communication functions. A downlink (DL) refers to a radio link via which a base station transmits a signal to a terminal, and an uplink (UL) refers to a radio link via which a terminal transmits a signal to a base station.

Embodiments of the disclosure may be applied to other communication systems having similar technical backgrounds or channel types to those discussed herein.

A communication system may employ various wired or wireless communication systems such as new RAN (NR) as a radio access network and packet core (5G system, 5G core network, or new generation core (NG Core)) as a core network, which are specified in the 5G communication standards defined by the 3rd generation partnership project (3GPP) that is a mobile communication standardization group. Based on determinations by those skilled in the art, the disclosure may be applied to other communication systems having similar backgrounds or channel types through some modifications without significantly departing from the scope of the disclosure.

In the following description, terms for identifying access nodes and referring to network entities, NFs, messages, interfaces between network entities, and various identification information, are illustratively used for the sake of descriptive convenience. Therefore, the disclosure is not limited by the terms as described below, and other terms referring to subjects having equivalent technical meanings may also be used.

In describing a communication service that provides an application-based QoS Herein, embodiments of the disclosure are described based on the XR service for convenience, but the disclosure may be applied to various data services in addition to the XR service. Therefore, it should be noted that the embodiments of the disclosure are not limited to the XR service.

When a communication network does not deliver the packets that are delivered but are not properly visible to the UE as described above, resources for transmitting unnecessary packets may be saved, which may help the performance of the communication network. When ADUs are generated according to characteristics of corresponding media for traffic of an application to be served to the user and packets corresponding to the ADUs are transmitted through the communication network, the ADUs may have a correlation with each other according to the characteristics of the media.

For example, a first ADU includes information that is essential when sending information transmitted to the user so that the first ADU has high importance. Thus, a packet corresponding to a second ADU may not be visible to the user without the first ADU having the high importance even though the packet corresponding to the second ADU is transmitted to the UE. Accordingly, relationship about the correlation between different ADUs and importance may be determined based on the ADUs. For example, when packets of the first ADU are transmitted, packets of the second ADU having less importance than the first ADU and having a high relationship with the first ADU may processed with low priority in scheduling and packet processing, or may be discarded when necessary. When processing packets by using application-level information, resources used in the network may be effectively used, thereby improving the user's service experience.

From a communication network, an ADU may be viewed as a collection of PDUs and thus, may be referred to as a PDU set. An ADU and a PDU set may be interchangeably used herein and are based on the same concept. However, an ADU may be viewed as a unit of application data delivered when serviced outside a communication network, and may be referred to as a PDU set when the ADU is serviced within the communication network.

When serviced in a communication network, packets corresponding to a PDU set may be subjected to existing PDU-level QoS processing, and may be additionally subjected to PDU set-level QoS processing as needed. To perform the PDU set-level QoS processing in the communication network, in the case of downlink data, a PDU session anchor (PSA) UPF of the communication network discovers PDU set information and includes the PDU set information in a general packet radio service (GPRS) tunneling protocol user plane (GTP-U) header that is forwarded, thus enabling the PDU set-level QoS processing within the radio access network (RAN).

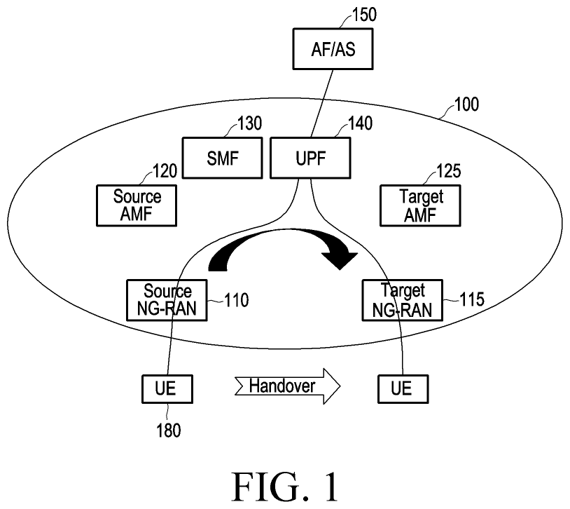

FIG. 1 illustrates an example of a transmission path for data traffic in a handover in a wireless communication system according to an embodiment.

Referring to FIG. 1, an example is shown in which transmission paths through which XR data traffic according to an XR service used by a user is delivered via a source next-generation RAN (NG-RAN) node 110 or a target NG-RAN node 115 in a handover.

Herein, a network technology may be referenced in relevant standards defined by the international telecommunication union (ITU) or the 3rd generation partnership project (3GPP), and components included in a network structure of FIG. 1 may respectively refer to physical entities, software that performs separate functions, or hardware combined with the software. Hereinafter, reference symbols such as N1, N2, and N3 indicate known interfaces between NFs in a 5G core network (CN), and a relevant description may be found in the relevant standard. Thus, a detailed description thereof will be omitted. Since a basic description of a handover procedure may also be found in the relevant standard, a detailed description thereof will be omitted.

The wireless communication system of FIG. 1 may include NR-RANs 110 and 115 and a 5G core network (5 GC) 100, and the NG-RANs 110 and 115 may include a base station (e.g., a gNB and an integrated access and backhaul (IAB) that supports a radio access technology in a 5G system. When a UE 180 moves from a serving or source NG-RAN 110, which previously serves the UE 180, to a target NG-RAN 115 according to a handover and receives a service, the NG-RANs 110 and 115 may have different QoS handling functions according to PDU sets in the serving or source NG-RAN 110 and the target NG-RAN 115. Herein, support for a QoS handling function according to a PDU set in an NG-RAN may be referred to as support for a PDU set function or PDU set support, and may be used interchangeably therewith.

The serving or source NG-RAN 110 may apply QoS according to a PDU set but the target NG-RAN 115 may not support a PDU set and thus applies QoS according to a PDU. Alternatively, the serving or source NG-RAN 110 may not support a PDU set and thus applies QoS according to a PDU but the target NG-RAN 115 applies QoS according to a PDU set. When the NG-RAN 110 and 115 do not support a PDU set, a PSA UPF may or may not perform a function of discovering PDU set information.

In FIG. 1, the 5 GC 100 may include network entities, such as AMFs 120 and 125, an SMF 130, a UPF 140. In an embodiment, the 5GC 100 may include at least one of a policy control function (PCF), and a unified data management (UDM).

The AMFs 120 and 125 manage access and mobility of a UE and may serve as an endpoint of a UE-core network where the UE connects to one or more different entities of the 5GC through the NG-RANs. For example, the AMF AMFs 120 and 125 may perform a network function, such as registration, connection, reachability, mobility management, access confirmation, authentication, and mobility event generation of the UE.

The SMF 130 may perform a function of managing a PDU session of the UE. The SMF 130 may perform a network function, such as a session management function through establishing, modifying, and releasing a session and maintaining a tunnel between the UPF 140 and the NG-RANs 110 and 115 required therefor, and allocating and managing an Internet protocol (IP) address of a UE, user plane selection and control, traffic processing control in the UPF, and charging data collection control.

The UPF 140 may serve to process XR data of the UE, and may serve to process XR data such that XR data generated by the UE may be delivered to an application function (AF)/application server (AS) 150 or data introduced from the AF/AS 150 may be delivered to the UE. The UPF 140 may perform a network function, such as the role of an anchor between RATs, provision of a connection between a PDU session and the AF/AS, packet routing and forwarding, packet inspection, application of a user plane policy, traffic usage report writing, and buffering.

The UDM may perform functions of generating authentication information for 3GPP security, processing a user identifier (ID), managing a list of network functions (NFs) supporting the UE, and managing subscription information. A unified data repository (UDR) may perform functions of storing and providing the subscription information managed by the UDM, structured data for exposure, and application data associated with a network exposure function (NEF) or a service. The UDR may store subscription information about the UE, and may provide the subscription information to the UDM.

The PCF is an NF that manages operator policy information for providing a service in the 5G system. The UDR may store the operator policy information, and may provide the operator policy information to the PCF.

The NEF externally transmits or receives an event occurring in the 5G system and a supporting capability. For example, the NEF may safely supply information about the AF/AS 150 to the 5GC, convert internal/external information, and store information received from a different NF in the UDR and redistribute the information.

The UE (or terminal) 180 may connect to the NG-RAN 110 to register with the 5G system 100 and perform a UE registration procedure with the AMF 120. In the registration procedure, the AMF 120 may determine a network slice available to the UE connected to the NG-RAN 110, and may allocate the network slice to the UE.

The UE may select a network slice to establish a PDU session for communication with the AF/AS 150. One PDU session may include one QoS flow or a plurality of QoS flows, and each QoS flow may provide different transmission performances required for each application service by configuring different QoS parameters.

For a QoS flow allowed to be serviced in the target NG-RAN 115 through a handover, data forwarded from the serving NG-RAN 110 to the target NG-RAN 115 and data traffic forwarded from the UPF 140 to the target NG from the UPF 140 may be scheduled and transmitted to the UE according to a received QoS profile or QoS parameters. In particular, when PDU set-level QoS parameters are provided for the QoS flow and QoS handling is performed for a PDU set, a value for data forwarding or PDU set-based QoS handling may be determined to smoothly provide a service even in the handover.

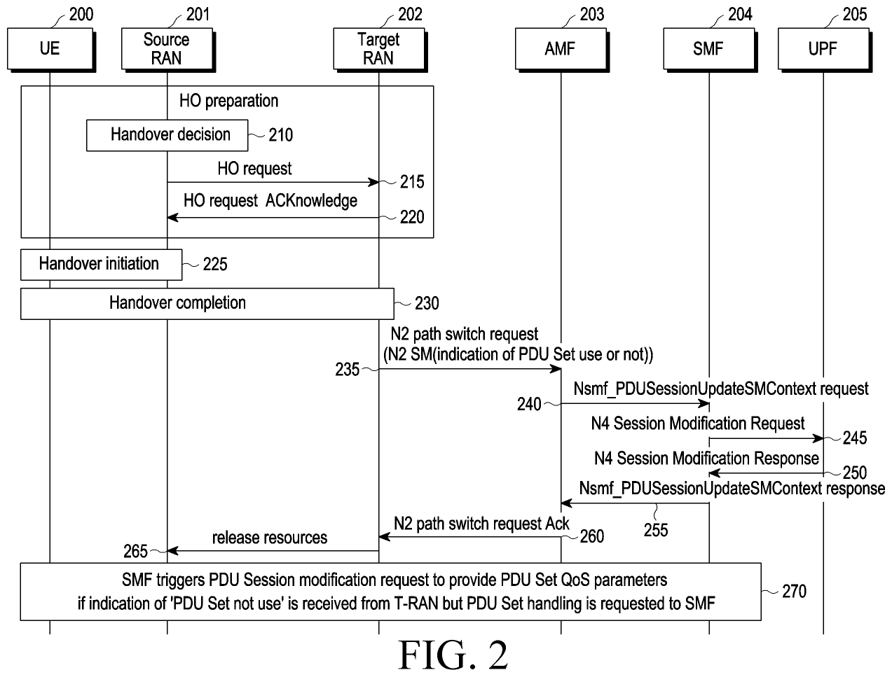

FIG. 2 illustrates a handover method considering a PDU set function in an Xn handover in a wireless communication system according to an embodiment.

Referring to FIG. 2, a UE 200 moves from a source RAN 210 to a target RAN through an Xn handover for an XR service for a user terminal.

In step 210, the source RAN 201 may determine to perform a handover. In step 215, the source RAN 201 may transmit a handover request to the target RAN 202. In step 220, the target RAN 202 may transmit an acknowledgment (ACK) of the handover request to the source RAN 201.

In step 225, the UE 200 and the source RAN 201 may initiate a handover procedure. In step 230, the handover procedure between the UE 200, the source RAN 201, and the target RAN 202 may be completed.

When a QoS parameter based on a PDU set is used in the source RAN, the source RAN 201 in step 215 may deliver a QoS profile provided for each QoS flow to the target RAN 202 through a message, such as an HO request. The QoS profile may include the QoS parameter(s). In this case, information such as a QoS profile for a QoS flow serviceable in the target RAN 202 may be transmitted through the handover.

In step 235, the target RAN 202 may transmit an N2 path switch request message indicating that the handover between the RANs is completed to modify a data path to an AMF 203. When the target RAN 202 supports PDU set handling, the target RAN 202 may include an indication that the target RAN supports a PDU set, such as PDU set based handling support indication, an indication of PDU set support, or indication of PDU set use), in an N2 session management (SM) container of the N2 path switch request message. When the target RAN 202 does not support PDU set handling, the target RAN 202 may not include PDU set based handling support indication, the indication of PDU set support, or indication of PDU set use) in the N2 SM container of the N2 path switch request message even though the PDU set QoS parameter(s) is received from the source RAN 201.

It is noted that indication of PDU set support and indication of PDU set use are used with the same purpose and meaning and the two terms are interchangeably used herein.

In step 240, the AMF 203 may deliver the N2 SM container to an SMF 204 through a Nsmf_PDU SessionUpdateSMContext request message.

When the target RAN 202 supports the PDU set in step 235, the target RAN 202 may transmit the N2 path switch request message to the AMF 203 by including the indication of PDU set use or an indication of “whether PDU Set QoS parameter is accepted or not” in the N2 SM container of the N2 path switch request message. In step 240, the AMF 203 may deliver the N2 SM container to the SMF 204 through the Nsmf_PDU SessionUpdateSMContext request message. The indication of PDU set use or indication of “whether PDU Set QoS parameter is accepted or not” may indicate that the target RAN 202 supports the PDU set, and may additionally indicate whether the target RAN 202 uses a received PDU set QoS parameter when receiving the PDU set QoS parameter from the source RAN 201 when the indication of “whether PDU Set QoS parameter is accepted or not” is indicated as accepted.

When the target RAN 202 receives the PDU set QoS parameter from the source RAN 201 and uses the received PDU set QoS parameter, the indication of PDU set use or indication of “whether PDU Set QoS parameter is accepted or not” may indicate a value indicating that the PDU set is used or that the PDU set QoS parameter is accepted (e.g., 0 or an indication of “accepted”). When the target RAN 202 does not receive the PDU set QoS parameter from the source RAN 201, the indication of PDU set use or “whether PDU Set QoS parameter is accepted or not” may indicate a value indicating that the PDU set is not available or “whether PDU Set QoS parameter is accepted or not” is indicated as not accepted (e.g., 1 or an indication of “not accepted”).

Alternatively, when the PDU set QoS parameter from the source RAN 201 is not received, the target RAN 202 may not include a separate indicator indicating PDU set use or PDU set QoS parameter acceptance in step 235.

Thus, in step 240, the SMF 204 receiving the Nsmf_PDU SessionUpdateSMContext request message may identify whether the target RAN supports the PDU set or whether the target RAN 202 receives the PDU set QoS parameter from the source RAN 201 and use of the PDU set QOS parameter from the indication received from the target RAN 202 is accepted.

In step 245, the SMF 204 may transmit an N4 session modification request to a UPF 205. In step 250, the UPF 205 may transmit an N4 session modification response to the SMF 204. In step 255, the SMF 204 may transmit an Nsmf_PDUSessionUpdateSMContext response to the AMF 203. In step 260, the AMF 203 may transmit an N2 path switch request Ack to the target RAN 202. In step 265, the target RAN 202 may request release resources from the source RAN 201.

In step 270, when the SMF 204 recognizes that the target RAN 202 supports the PDU set but has no PDU set QoS parameter for a QoS flow on which a policy of supporting the PDU set is received, such as when the indication of PDU set use indicates that the PDU set is unavailable, when the indication of “whether PDU Set QoS parameter is accepted or not” is indicated as “not accepted”, or when the indication of PDU set use or of “whether PDU Set QoS parameter is accepted or not” is not received from the target RAN 202, the SMF 204 may start a PDU session modification request process to transmit a PDU set QoS parameter value to the target RAN 202, and may transmit a QoS profile including the PDU set QoS parameter to the target RAN 202 through an N2 SM container in this process.

The PDU set QoS parameter may include at least one of a PDU set delay budget (PSDB), a PDU set error rate (PSER), and a PDU set integrate handing indicator (PSIHI).

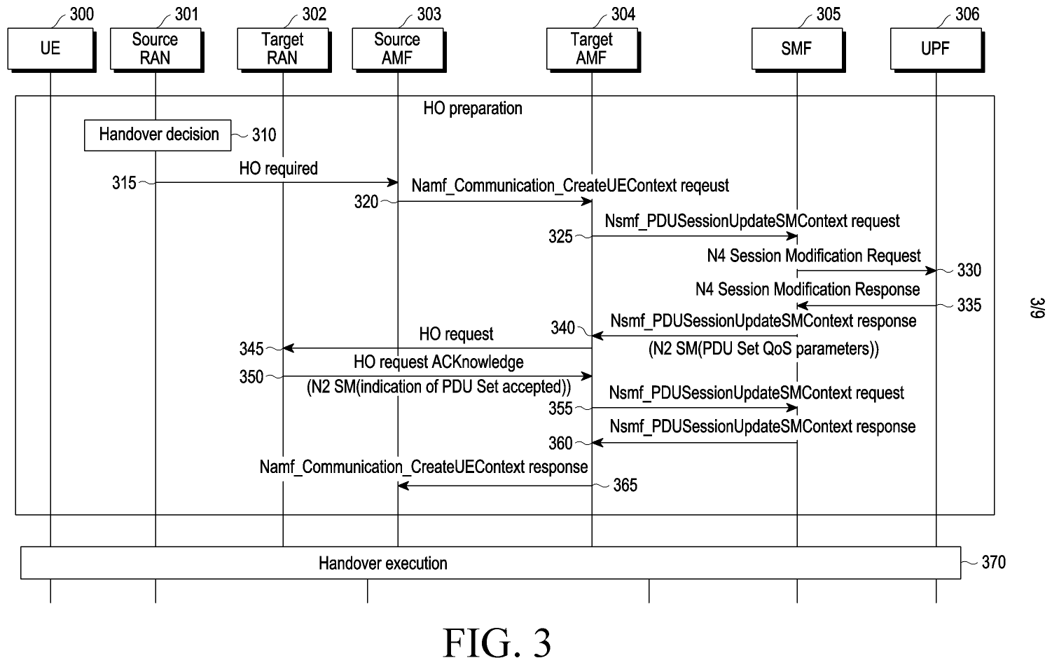

FIG. 3 illustrates a handover method considering a PDU set function in an N2 handover in a wireless communication system according to an embodiment.

Referring to FIG. 3, steps 310 to 365 are included in a handover (HO) preparation procedure. Steps 310, 315, 320, 325, 330 and 335 correspond to a general handover preparation procedure, and a description thereof is omitted.

When there is a QoS flow for which an SMF 330 receives a policy to support a PDU set, the SMF 305 may transmit a PDU set QoS parameter(s) for the QoS flow to a target AMF 304 as being included in an N2 SM container of a Nsmf_PDUSessionUpdateSMContext response message in step 340 of the HO preparation procedure for preparing for an N2 handover. In step 345, the target AMF 304 may transmit the N2 SM container including the PDU set QoS parameter to a target RAN 302 through an HO request message. In step 350, the target RAN 302 may transmit to the target AMF 304 an indication indicating that the PDU set QoS parameter is accepted and available by the target RAM 302 in an N2 SM container of an HO request ACK message, such as an indication of PDU set accepted, an indication of PDU set use, an indication of PDU set support, PDU set based handling support indication or an indication of “whether PDU Set Qos parameter is accepted or not” that is “accepted”. In step 355, the target AMF 304 may transmit the N2 SM container to the SMF 305 through a Nsmf_PDUSessionUpdateSMContext request message. Steps 355, 360, 365, and 370 are included in a general handover procedure, and a description thereof is omitted.

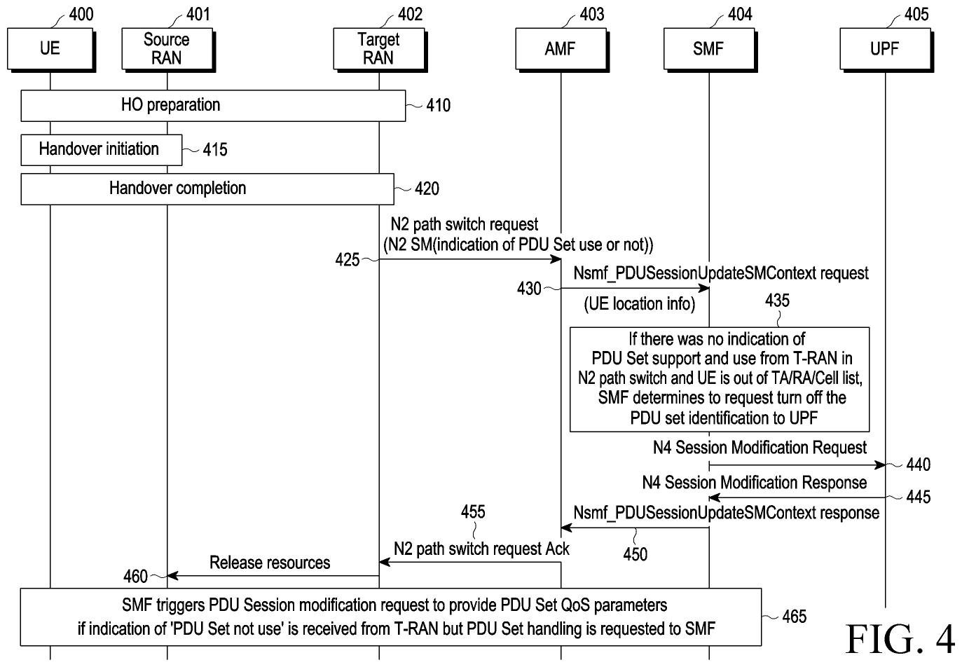

FIG. 4 illustrates a handover method considering whether a core network uses a PDU set recognition function in an Xn handover of a high-speed UE in a wireless communication system according to an embodiment.

To process a PDU set in the wireless communication system, a UPF needs to support a function of discovering information about the PDU set and to include the information about the PDU set in a GTP-U header when transmitting (forwarding) packets to an NG-RAN, and the NG-RAN needs to support a function of processing a corresponding packet, based on the transmitted information about the PDU set.

Since the UPF is able to serve a larger coverage area than the NG-RAN, the UPF may not change when a UE moves the NG-RAN during a handover. Therefore, packet handling through a PDU set is possible in the communication system only when both the NG-RAN and the UPF support a PDU set function. Accordingly, when the NG-RAN does not support the PDU set function or when the UPF does not support the PDU set function, an SMF is unable to apply a PDU set even though receiving a policy of applying the PDU set to a QoS flow. Therefore, when a newly moved target NG-RAN does not support a PDU set for a QoS flow to which the PDU set is applied, the SMF may transmit an N4 message so that the UPF does not use the PDU set function for the QoS flow, thereby disabling the UPF from further performing PDU set identification.

However, as a handover of a high-speed UE frequently occurs, whether the RAN supports the function may frequently change, in which case turning on and off the PDU set function of the UPF each time may cause unnecessary loads to the system. To this end, a condition under which the SMF requests the UPF to turn on or off the PDU set function may be adjusted.

Referring to FIG. 4, steps 410, 415 and 420 are the same as steps 210 to 230 of FIG. 2, and thus a description thereof is omitted.

In step 425, a target RAN 402 may transmit an N2 path switch request message indicating that a handover between RANs is completed to modify a data path to an AMF 403. In an embodiment, the target RAN 402 may include PDU set based handling support indication, an indication of PDU set use, or an indication of PDU set support) indicating that the target RAN 402 supports the PDU set function in an N2 SM container of the N2 path switch request message. In an embodiment, the target RAN 402 may include a value of an indication of PDU set use, or a value of an indication of “whether PDU Set QoS parameter is accepted or not” (for example, 0 or “accepted”), the values indicating that a PDU set QoS parameter for using a PDU set is prepared and thus the PDU set is available in an N2 SM container of the N2 path switch request message. In an embodiment, the target RAN 402 may include a value of an indication of PDU set use or a value of an indication of “whether PDU Set QoS parameter is accepted or not” (for example, 1 or “not accepted”) the values indicating that the PDU set function is supported but the PDU set is unavailable due to the absence of the PDU set QoS parameter in an N2 SM container of the N2 path switch request message. Alternatively, the target RAN 402 may implicitly indicate that the target NG-RAN does not support the PDU set function by not including the indication of PDU set support in the N2 SM container of the N2 path switch request message.

In step 430, an AMF 403 may transmit the N2 SM container including the indication to an SMF 404 through a Nsmf_PDUSessionUpdateSMContext request message. Location information about a UE may also be transmitted to the SMF 404 and may include at least one of a tracking area (TA), a registration area (RA), the cell ID of the target NG-RAN, whether the UE is out of an area of interest, whether the UE is out of an existing TA, or whether the UE is out of the existing RA.

In step 435, in the case of a QoS flow on which a policy of applying a PDU set is received, the SMF 404 may determine to request a UPF 405 to turn off PDU set identification when the SMF 404 does not receive the indication of PDU set support, the indication PDU set use, and the indication of “whether PDU Set QoS parameter is accepted or not” from the target RAN 402 in step 430 and the UE is handed over to be out of a TA/RA/cell list. That is, even though the target NG-RAN 402 does not support a PDU set, the SMF 404 may determine whether the UPF uses the PDU set function, based on the received location information about the UE 400. When the PDU set function is used when the UE 400 is in a source RAN 401 but the target RAN 402 does not support the PDU set function when the UE 400 moves to the target RAN 402, the SMF 404 may determine that the UPF 405 turns off the PDU set function by transmitting an indication of turning off the PDU set function for the QoS flow. In step 440, the SMF 404 may transmit an N4 session modification request message including the indication of turning off the PDU set function for the QoS flow to the UPF 405.

A condition under which the SMF 404 causes the UPF 405 to turn off the PDU set function in the above situation are determined based on the location information about the UE 400. For example, when the location of the UE 400 is out of an area where a RAN supporting the PDU set function is installed, the SMF 404 may enable the UPF to turn off the PDU set function. Information about the area where the RAN supporting the PDU set function is installed may be provided to the SMF 404 through an operations & maintenance (O&M) function in a core network. Accordingly, the information about the area where the RAN supporting the PDU set function is installed may be provided as a combination including at least one of a list of TAs, a list of RAs, or a list of cell IDs. Therefore, the information about the area where the RAN supporting the PDU set function is installed may be determined as an area of interest, and may be reported by the AMF 403 to the SMF 404 when the UE 400 leaves the area.

When the UE 400 is moved from the source RAN 401 to the target RAN 402 but remains in the TA or RA, even though the PDU set function is used when the UE 400 is in the source RAN 401 but the PDU set function is not supported when the UE 400 moves to the target RAN 402, the SMF 404 may operate to enable the UPF 405 not to turn off the PDU set function. Accordingly, even though PDU set information is delivered to the target RAN 402 as being included in a GTP-U header of a packet transmitted by the UPF 405, the target RAN 402 may disregard the received

PDU set information, and may schedule a packet according to an existing PDU-based QoS parameter instead of a PDU set-based QoS parameter. However, when the UE 400 moves to the target RAN 402 and moves to a new TA or new RA and the target RAN 402 does not support the PDU set function, the SMF 404 may enable the UPF 405 to turn off the PDU set function.

In case that the indication of PDU set support, the indication of PDU set accepted, the indication of “whether PDU Set QoS parameter is accepted or not” that is “accepted”, or the indication of PDU Set use is not received, the SMF 404 may recognize that the target RAN 402 does not support the PDU set function. In case that the indication of “whether PDU Set QoS parameter is accepted or not” that is “not accepted” is received from the target RAN 402, the SMF 404 may recognize that the target RAN 402 does not support the PDU set function.

In step 445, the UPF 405 may transmit an N4 session modification response to the SMF 404. In step 450, the SMF 404 may transmit an Nsmf_PDUSessionUpdateSMContext response to the AMF 403. In step 455, the AMF 403 may transmit an N2 path switch request ACK to the target RAN 402. In step 460, the target RAN 402 may request the source RAN 401 to release resources.

In step 465, in case that the SMF 404 recognizes that the target RAN 402 supports the PDU set but has no PDU set QoS parameter for a QoS flow on which a policy of supporting the PDU set is received, (such as in case that the indication of PDU set use indicates that the PDU set is unavailable, the indication of “whether PDU Set QoS parameter is accepted or not” is indicated as “not accepted”, or the indication of PDU set support or the indication of “whether PDU Set QoS parameter is accepted or not” is not received from the target RAN 402) the SMF 404 may start a PDU session modification request process to transmit a PDU set QoS parameter value to the target RAN 402, and may transmit a QoS profile including the PDU set QoS parameter to the target RAN 402 through an N2 SM container in this process.

The PDU set QoS parameter may include at least one of a PSDB, a PSER, and a PSIHI.

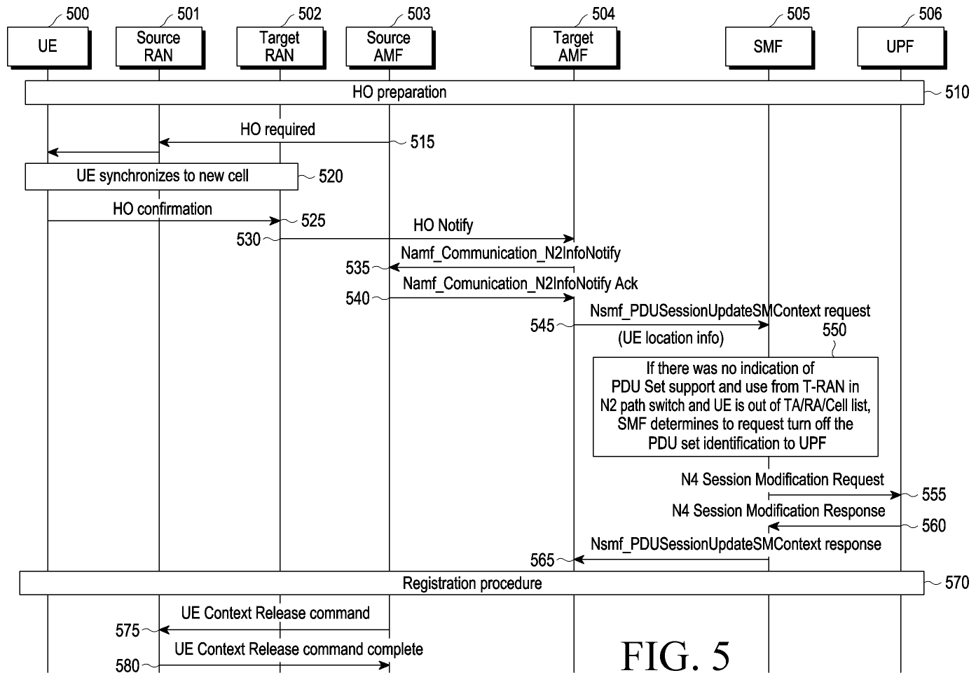

FIG. 5 illustrates a handover method considering whether a core network uses a PDU set recognition function in an N2 handover of a high-speed UE in a wireless communication system according to an embodiment.

To process a PDU set in the wireless communication system, a UPF needs to support a function of discovering information about the PDU set and to include the information about the PDU set in a GTP-U header when transmitting (forwarding) packets to an NG-RAN, and the NG-RAN needs to support a function of processing a corresponding packet, based on the transmitted information about the PDU set.

Since the UPF is able to serve a larger coverage area than the NG-RAN, the UPF may not change when a UE moves the NG-RAN during a handover. Therefore, packet handling through a PDU set is possible in the communication system only when both the NG-RAN and the UPF support a PDU set function. Accordingly, when the NG-RAN does not support the PDU set function or when the UPF does not support the PDU set function, an SMF is unable to apply a PDU set even though receiving a policy of applying the PDU set to a QoS flow. Therefore, when a newly moved target NG-RAN does not support a PDU set for a QoS flow to which the PDU set is applied, the SMF may transmit an N4 message so that the UPF does not use the PDU set function for the QoS flow, disabling the UPF from further performing PDU set identification.

However, as a handover of a high-speed UE frequently occurs, whether the RAN supports the function may frequently change, in which case turning on and off the PDU set function of the UPF each time may actually cause unnecessary loads to the system. To this end, conditions under which the SMF requests the UPF to turn on or off the PDU set function may be adjusted.

Referring to FIG. 5, in a handover preparation procedure of step 510, when supporting the PDU set function, the target RAN 502 may transmit an indication of PDU set accepted, PDU set support, PDU set use, or “whether PDU Set QoS parameter is accepted or not” to an SMF 505 through a target AMF 504 as shown in FIG. 3. Steps 515, 520, 525, 530, 535, and 540 follow a general X2 handover procedure, and a description thereof is omitted in the disclosure.

In step 545, the target AMF 504 may transmit an Nsmf_PDUSessionUpdateSMContext request message including location information about a UE 500 to the SMF 505 during an N2 handover. The location information may include at least one of a TA, an RA, the cell ID of the target NG-RAN, whether the UE 500 is out of an area of interest, whether the UE 500 is out of an existing TA, or whether the UE 500 is out of the existing RA.

In step 550, in the case of a QoS flow on which a policy of applying a PDU set is received, the SMF 505 may determine to request a UPF 506 to turn off PDU set identification when the SMF 505 does not receive the indication of PDU set support, PDU set use, PDU set accepted, or “whether PDU Set QoS parameter is accepted or not” from the target RAN 502 and the UE is handed over to be out of a TA/RA/cell list. That is, even though the target NG-RAN 502 does not support a PDU set, the SMF 505 may determine whether the UPF 506 uses the PDU set function, based on the received location information about the UE 500. Although the PDU set function is used when the UE 500 is in a source RAN 501 but the PDU set function is not supported when the UE 500 moves to the target RAN 502, the SMF 505 may operate to enable the UPF 506 not to turn off the PDU set function. In step 555, the SMF 505 may transmit an N4 session modification request message including an indication of turning off the PDU set function for the QoS flow to the UPF 506.

A condition under which the SMF 505 causes the UPF 506 to turn off the PDU set function in the above situation is determined based on the location information about the UE 500. For example, when the location of the UE 500 is out of an area where an RAN supporting the PDU set function is installed, the SMF 505 may enable the UPF 506 to turn off the PDU set function. Information about the area where the RAN supporting the PDU set function is installed may be provided to the SMF 505 through an O&M function in a core network. Accordingly, the information about the area where the RAN supporting the PDU set function is installed may be provided as a combination including at least one of a list of TAs, a list of RAs, or a list of cell IDs. Therefore, the information about the area where the RAN supporting the PDU set function is installed may be determined as an area of interest, and may be reported by the AMF 503 to the SMF 505 when the UE 500 leaves the area.

When the UE 500 is moved from the source RAN 501 to the target RAN 502 but remains in the TA or RA, even though the PDU set function is used when the UE 500 is in the source RAN 501 but the PDU set function is not supported when the UE 500 moves to the target RAN 502, the SMF 505 may operate to enable the UPF 506 not to turn off the PDU set function. Accordingly, even though PDU set information is delivered to the target RAN 502 as being included in a GTP-U header of a packet transmitted by the UPF 506, the target RAN 502 may disregard the received PDU set information, and may schedule a packet according to an existing PDU-based QoS parameter instead of a PDU set-based QoS parameter. However, when the UE 500 moves to the target RAN 502 and moves to a new TA or new RA and the target RAN 502 does not support the PDU set function, the SMF 505 may transmit an N4 message including an indication of turning off the PDU set function for the QoS flow to the UPF 506, thereby enabling the UPF 506 to turn off the PDU set function.

When the indication of PDU set support, PDU set accepted, PDU set use, and “whether PDU Set QoS parameter is accepted or not” are not received from the target RAN 502 in a handover preparation or execution operation, the SMF 505 may recognize that the target RAN 502 does not support the PDU set function.

Steps 560, 565, 570, 575 and 580 correspond to a general handover procedure, and a description thereof is omitted in the disclosure.

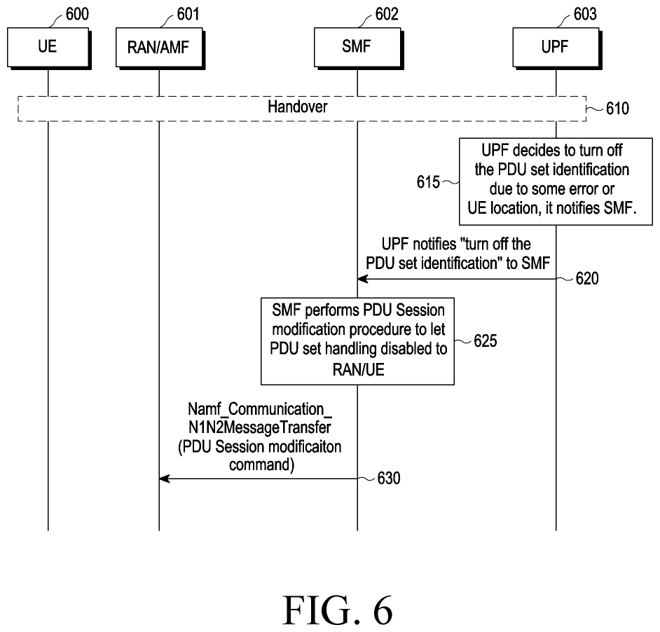

FIG. 6 illustrates a method of determining whether to use a PDU set function through a report of a core network in a handover in a wireless communication system according to an embodiment.

Referring to FIG. 6, after a handover procedure is performed in step 610, a UPF 603 may determine to turn off a PDU set identification function, in step 615 As a condition for turning off the PDU set function, a case where an RAN where a UE is located is in a location where a PDU set is not supported or a case where the UPF has a problem (error) in performing PDU set identification may be considered. Regarding information about the location where the PDU set is supported, whether a RAN connected to the UPF through an N3 tunnel is in the location where the PDU set is supported may be provided through a RAN ID or a cell ID through an O&M function in a core network.

In step 620, when the UPF 603 determines to turn off the PDU set function thereof, the UPF 603 may report to an SMF that the UPF 603 turns off the PDU set function for a corresponding QoS flow. In step 625, the SMF 602 may perform a PDU session modification procedure such that the RAN and the UE do not support the PDU set function for the QoS flow.

In step 630, the SMF 602 may transmit Namf_Communication_NIN2MessageTransfer including an indication of disabling PDU set handling. Specifically, the SMF 602 may transmit Namf_Communication_NIN2MessageTransfer including a PDU session modification command message to an AMF 601, in which case the SMF 602 may include an indication of disabling PDU set handling for the QoS flow in an N2 SM container, and may include an indication of disabling PDU set handling in the PDU session modification command message carried in an N1 SM container.

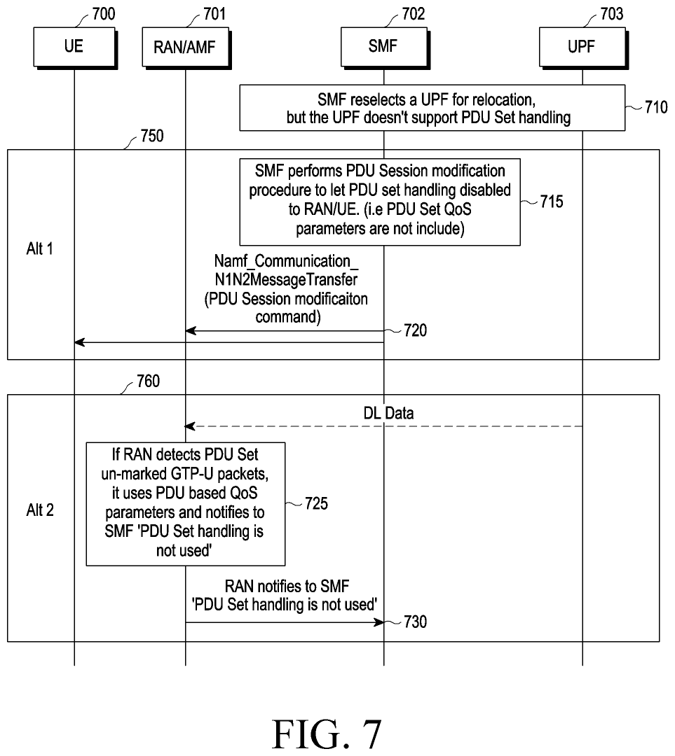

FIG. 7 illustrates a method of determining whether to use a PDU set function when a UPF is changed in a wireless communication system according to an embodiment.

Referring to FIG. 7, in step 710, when an SMF 702 relocates a UPF 703 according to the movement of a UE 700, the SMF 702 may reselect a UPF that does not support PDU set handling. That is, when selecting the UPF 703, the SMF 702 receiving a policy of applying a PDU set to a QOS flow may select the UPF considering whether the UPF supports a PDU set identification function. However, when there is no UPF that supports PDU set identification, the SMF 702 may select a UPF that does not have the PDU set function as a second-best solution. That is, the UPF 703 does not have a PDU set identification function, and is thus unable to apply PDU set handling to the QoS flow.

When the UPF that does not support PDU set handling is selected, alternative 1 (Alt 1) 750 and alternative 2 (Alt 2) 760 may be performed to not apply PDU set handling. Alt 1 750 includes steps 715 and 720. In step 715, the SMF 702 may trigger a PDU session modification process and not transmit a PDU set QoS parameter to the UE and an RAN, thereby not applying PDU set handling.

In step 720, the SMF 702 may transmit Namf_Communication_NIN2MessageTransfer including an indication of disabling PDU set handling or a QoS profile with a PDU Set Qos parameter deleted. Further in step 720, the SMF 702 may transmit Namf_Communication_NIN2MessageTransfer including a PDU session modification command message to an AMF 701, in which case, the SMF 702 may include an indication of deleting the PDU set QoS parameter from the QoS profile or disabling PDU set handling for the QoS flow in an N2 SM container, and disabling PDU set handling in the PDU session modification command message carried in an N1 SM container.

Alt 2 760 includes steps 725 and 730. In step 725, when the RAN 701 detects a GTP-U packet not including PDU set information for downlink packets for a QoS flow received from the UPF 703, the RAN 701 may apply an existing PDU-based QoS parameter to the QoS flow instead of a PDU set QoS parameter. In step 730, the RAN 701 may transmit an NS SM container including an indication of “PDU Set handling is not used” to the SMF 702.

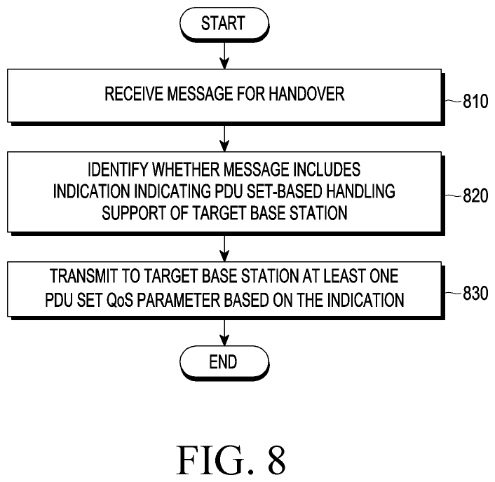

FIG. 8 illustrates an operation of an SMF entity according to an embodiment. For example, the SMF entity illustrated in FIG. 8 may support a handover of a UE.

Referring to FIG. 8, the SMF entity may receive, from a target base station, a first message for a handover in step 810. In an embodiment, the SMF entity of the disclosure may receive a session update request message for the handover from an AMF.

In step 820, the SMF entity may identifying whether the first message includes a first indication indicating a protocol data unit (PDU) set-based handling support of the target base station. In an embodiment, the SMF entity may identify whether the message includes a first indicator indicating PDU set-based QoS support of a target base station related to the handover.

In step 830, the SMF entity may transmit, to the target base station, at least one PDU set quality of service (QOS) parameter based on the first indicator. In an embodiment, the SMF entity may request a UPF to deactivate PDU set identification in packet transmission, based on the first indicator and location information about the UE included in the message. When the first indicator is not included in the message and the location information about the UE is a location outside an area in which the PDU set-based QoS support is provided, the SMF entity may request the UPF to deactivate PDU set identification. The area in which the PDU set-based QoS support is provided may be provided by information including at least one of a list of TAs, a list of RAs, or a list of cell IDs.

In an embodiment, the first indicator indicating the PDU set-based QoS support of the target base station related to the handover may indicate whether the target base station receives a PDU set-based QoS parameter from a source base station related to the handover and is able to use the PDU set-based QoS parameter or accepts use of the PDU set-based QoS parameter.

In an embodiment, when the first indicator indicates the PDU set-based QoS support but indicates that the PDU set-based QoS parameter is unavailable, the SMF entity may transmit a PDU set QoS parameter for a QoS flow to which a policy of supporting a PDU set is applied to the target base station.

In an embodiment, the first indicator may be received from the target base station through the AMF, and may be included in an N2 SM container.

In an embodiment, the PDU set QoS parameter for the QoS flow to which the policy of supporting the PDU set is applied may be included in the N2 SM container. The SMF entity may receive a notification of deactivation of the PDU set identification for a QoS flow from the UPF, and may transmit a second indicator of deactivating a PDU set function for the QoF flow to the target base station and the UE, based on the notification.

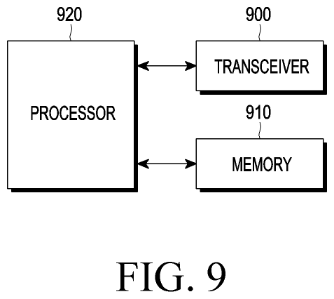

FIG. 9 illustrates the structure of a network node according to an embodiment.

Referring to FIG. 9, the network node may include an SMF, a UPF, a RAN, a UE, and other related components described herein.

The network node according to an embodiment of the disclosure may include a processor 920 configured to control the overall operation of the network node, a transceiver 900 including a transmitter and a receiver, and memory 910. The network node is not limited to the above example, and may include more or fewer components than those illustrated in FIG. 9.

According to an embodiment of the disclosure, the transceiver 900 may transmit and receive a signal to and from network entities or another network node. The signal transmitted to and received from the network entities may include control information and data. In addition, the transceiver 900 may receive a signal through a wireless channel to output the signal to the processor 920, and may transmit a signal output from the processor 920 through the wireless channel.

According to an embodiment of the disclosure, the processor 920 may control the network node to perform any one operation of the foregoing embodiments. The processor 920, the memory 910, and the transceiver 900 are not necessarily configured as separate modules, but may be configured as a single component in the form of a single chip. The processor 920 and the transceiver 900 may be electrically connected. The processor 920 may be an application processor (AP), a communication processor (CP), a circuit, an application-specific circuit, or at least one processor.

According to an embodiment of the disclosure, the memory 910 may store data, such as a basic programs, an application program, and configuration information for the operation of the network node. In particular, the memory 910 provides the stored data upon request from the processor 920. The memory 910 may be configured as a storage medium, such as read only memory (ROM), random access memory (RAM), a hard disk, CD-ROM, and a digital versatile disc (DVD), or a combination of storage media. There may be a plurality of memories 910. The processor 920 may perform the foregoing embodiments, based on a program for performing the foregoing embodiments of the disclosure stored in the memory 910.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or CPU.

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to embodiments of the disclosure.

These software modules or software may be stored in non-volatile memories including a random access memory and a flash memory, a ROM, an electrically erasable programmable read only memory (EEPROM), a magnetic disc storage device, a compact disc-ROM (CD-ROM), DVDs, or other type optical storage devices, or a magnetic cassette. Alternatively, any combination of some or all of the software may form a memory in which the program is stored. In addition, a plurality of such memories may be included in the electronic device.

The programs may be stored in an attachable storage device which can access the electronic device through communication networks such as the Internet, Intranet, local area network (LAN), Wide LAN (WLAN), and storage area network (SAN) or a combination thereof. Such a storage device may access the electronic device via an external port. A separate storage device on the communication network may access a portable electronic device.

Although the above embodiments have been described based on 5G and NR systems, other variants based on the technical idea of the embodiments may also be implemented in other systems such as LTE, LTE-A, and LTE-A-Pro systems.

Herein, a unit refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. Moreover, the elements and units may be implemented to reproduce one or more CPUs within a device or a security multimedia card. The unit in the embodiments may include one or more processors.

Herein, at each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method of a session management function (SMF) entity in a wireless communication system, the method comprising:
receiving, from a target base station, a first message for a handover;
identifying whether the first message includes a first indication indicating a protocol data unit (PDU) set-based handling support of the target base station; and
transmitting, to the target base station, at least one PDU set quality of service (QOS) parameter based on the first indication.

2. The method of claim 1, wherein transmitting the at least one PDU set QoS parameter includes:
transmitting, to the target base station, the at least one PDU set QoS parameter, in case that the first indication indicates the PDU set-based handling support and indicates that at least one PDU set-based QoS parameter received from a source base station is unavailable for the target base station.

3. The method of claim 1, further comprising:
in case that the first indication is not included in the first message, deactivating PDU set identification related to a user plane function (UPF) entity.

4. The method of claim 3,
wherein deactivating the PDU set identification includes requesting the UPF to deactivate the PDU set identification in case that the first indication is not included in the message and location information about the UE indicates a location outside a predetermined area.

5. The method of claim 1,
wherein the first indication indicates whether the target base station receives the at least one PDU set-based QoS parameter from a source base station related to the handover and whether the target base station is able to use the at least one PDU set-based QoS parameter or accepts use of the at least one PDU set-based QoS parameter.

6. The method of claim 1,
wherein the first indication is included in an N2 session management (SM) container in the first message.

7. The method of claim 1,
wherein the at least one PDU set QoS parameter is included in an N2 session management (SM) container.

8. A method of a target base station in a wireless communication system, the method comprising:
transmitting, to a session management function (SMF) entity, a first message for a handover; and
receiving, from the SMF entity, at least one PDU set quality of service (QOS) parameter in case that the first message includes a first indication indicating a protocol data unit (PDU) set-based handling support of the target base station.

9. The method of claim 8,
wherein the first indication is included in an N2 session management (SM) container in the first message.

10. The method of claim 8,
wherein the at least one PDU set QoS parameter is included in an N2 session management (SM) container.

11. A session management function (SMF) entity in a wireless communication system, the SMF entity comprising:
a transceiver; and
at least one processor coupled to the transceiver and configured to:
receive, from a target base station, a first message for a handover,
identify whether the first message includes a first indication indicating a protocol data unit (PDU) set-based handling support of the target base station, and
transmit, to the target base station, at least one PDU set quality of service (QOS) parameter based on the first indication.

12. The SMF entity of claim 11, wherein the least one processor is further configured to:
transmit, to the target base station, the at least one PDU set QoS parameter, in case that the first indication indicates the PDU set-based handling support and indicates that at least one PDU set-based QoS parameter received from a source base station is unavailable for the target base station.

13. The SMF entity of claim 11, wherein the least one processor is further configured to:
in case that the first indication is not included in the first message, deactivate PDU set identification related to a user plane function (UPF) entity.

14. The SMF entity of claim 13, wherein the least one processor is further configured to:
request the UPF to deactivate the PDU set identification in case that the first indication is not included in the message and the location information about the UE indicates a location outside a predetermined area.

15. The SMF entity of claim 11,
wherein the first indication indicates whether the target base station receives the at least one PDU set-based QoS parameter from a source base station related to the handover and whether the target base station is able to use the at least one PDU set-based QoS parameter or accepts use of the at least one PDU set-based QoS parameter.

16. The SMF entity of claim 11,
wherein the first indication is included in an N2 session management (SM) container.

17. The SMF entity of claim 11,
wherein the at least one PDU set QoS parameter is applied is included in an N2 session management (SM) container.

18. A target base station in a wireless communication system, the target base station comprising:
a transceiver; and
at least one processor coupled to the transceiver and configured to:
transmit, to a session management function (SMF) entity, a first message for a handover, and
receive, from the SMF entity, at least one PDU set quality of service (QOS) parameter in case that the first message includes a first indication indicating a protocol data unit (PDU) set-based handling support of the target base station.

19. The target base station of claim 18,
wherein the first indication is included in an N2 session management (SM) container in the first message.

20. The target base station of claim 18,
wherein the at least one PDU set QoS parameter is included in an N2 session management (SM) container.
